(19) United States
(12) Patent Application Publication
(10) Pub. No.: US 2021/0090166 A1
(43) Pub. Date: Mar. 25, 2021

(54) System and Method for Acquiring a Cryptocurrency in Exchange for Completing a Financial Transaction of Another

(71) Applicant: Anthony Bayne, Lomita, CA (US)

(72) Inventor: Anthony Bayne, Lomita, CA (US)

(21) Appl. No.: 16/581,755

(22) Filed: Sep. 25, 2019

(51) Int. Cl. G06Q 40/04; G06Q 20/38; G06Q 20/42; G06Q 20/40; G06Q 20/36; G06Q 20/06

(52) U.S. Cl. CPC G06Q 40/04; G06Q 20/3829; G06Q 20/42; G06Q 2220/00; G06Q 20/4014; G06Q 20/3674; G06Q 20/065; G06Q 20/405

(57) ABSTRACT

System and method to provide for acquiring a cryptocurrency via an exchange. A cryptocurrency owner's financial transaction is completed by another in exchange for an amount of cryptocurrency equal to the cost of completing the financial transaction, plus a premium, when the financial transaction cannot be paid for using the cryptocurrency owner's cryptocurrency.

### RELATED APPLICATIONS

The present application claims the benefit of U.S. Provisional Patent Application Ser. No. 67/740,428, filed Oct. 3, 2018 and Ser. No. 62/735,863, filed Sep. 25, 2018, which are hereby incorporated by reference as if set forth fully herein.

### BACKGROUND OF THE INVENTION

### Field of the Invention

The present invention generally relates to a system and method for acquiring a cryptocurrency, and more particularly the acquiring of a cryptocurrency via a purchase exchange.

A cryptocurrency is a form of digital currency that usually has no central issuing or regulating authority and uses a distributed ledger (i.e. blockchain) system to record transactions, manage the issuance of new units, and that relies on cryptography to prevent counterfeiting and fraudulent transactions. A cryptocurrency (e.g. Bitcoin) can be purchased from a cryptocurrency exchange (e.g. Coinbase), or from a private party, for its market value, plus a fee/commission. The fee is often calculated as a percentage of the market value of the cryptocurrency. For example, if a buyer purchases $1,000.00 of cryptocurrency, the buyer may also pay an additional 4% fee in addition to the $1000.00, or a total of $1,040.00. Alternatively, the buyer will receive only $960.00 worth of the cryptocurrency. In either case, the buyer will not receive $1,000 of cryptocurrency for a $1,000.00 payment.

Since many businesses, online and traditional, do not accept cryptocurrency payments, and cryptocurrency prices are sometimes volatile to the downside, many buyers do not want to pay an additional fee on top of the cryptocurrency's market value to purchase cryptocurrency. Reasons for businesses' non-acceptance of cryptocurrency payments include a lack of trust in cryptocurrencies and a lack of places to spend cryptocurrency.

In contrast, many businesses, online and brick-and-mortar, accept credit cards, debit card payments, and other non-cryptocurrency payments. Therefore, while business adoption of cryptocurrency payments is slowly growing, a need remains to allow cryptocurrency owners to use their cryptocurrency to complete financial transactions with businesses that do not yet accept cryptocurrency payments.

### SUMMARY OF CERTAIN INVENTIVE ASPECTS

The present invention meets the above described needs by allowing a credit cardholder to use his/her credit card to complete a financial transaction for a cryptocurrency owner in exchange for cryptocurrency being paid to the credit cardholder's cryptocurrency wallet.

As used herein, the term “credit cardholder” is to be interpreted broadly to include any person or entity that has the means to complete a cryptocurrency owner's financial transaction (e.g. purchase a book). For example, a credit cardholder includes a person who owns, uses, or possess a physical credit card or possesses enough credit card information (e.g. account number, security code, etc.) to complete a cryptocurrency owner's financial transaction. Further, the term “credit cardholder” includes a person who has a cryptocurrency that is of a different type of cryptocurrency than that of the cryptocurrency owner that is an acceptable means of payment to the financial transaction payee (e.g. the “credit cardholder” owns Bitcoin, and the cryptocurrency owner owns Ethereum, and the payee accepts Bitcoin only). Further, the term “credit card” should be interpreted to include not only a credit card, but also a checking account, a debit card, cash, and other choses in action that are acceptable payment to a payee of a financial transaction.

As used herein, the term “complete” in the phrase “complete a financial transaction”, includes completing an agreed upon portion of a financial transaction. For example, this may occur when the cryptocurrency owner wants the credit cardholder to make an installment payment of a larger financial transaction (e.g. an installment payment on a 30-year mortgage, or to satisfy a monthly payment on a two year lease, etc.). Further, as used herein, the term “financial transaction” should be interpreted broadly to include any agreed upon exchange of consideration. “Consideration” as used herein means a bargained for exchange of legal detriment.

Using certain embodiments of the invention, as described in further detail below, a credit cardholder will be able to acquire cryptocurrency equal to the cost of completing the financial transaction, plus a premium amount of cryptocurrency, for helping a cryptocurrency owner complete a financial transaction with a business that does not accept cryptocurrency payments (or at least does not accept the cryptocurrency that will be payed to the credit cardholder). This is the opposite of what presently occurs in purchasing cryptocurrency for its market value plus a commission/fee. Thus, the invention will enable a credit cardholder to acquire cryptocurrency without paying an additional fee above the market value cost of the subject cryptocurrency and help incentivize cryptocurrency ownership and use.

In a preferred embodiment, the cryptocurrency owner will pay the credit cardholder an amount of cryptocurrency equal to the cost of completing the cryptocurrency owner's financial transaction, plus a premium in the same cryptocurrency. The cryptocurrency owner will pay the premium for the convenience of having a financial transaction completed with a business that does not accept the cryptocurrency owner's cryptocurrency for payment. In this way, via an exchange, the invention enables cryptocurrency owners to complete more financial transactions. In an alternative embodiment the cryptocurrency owner can pay the credit cardholder a premium in a different form (e.g. a different cryptocurrency type, or an interest in the financial transaction).

However, since cryptocurrencies are sometimes volatile to the upside in price, in an alternate embodiment, a credit cardholder may waive or rebate (hereinafter collectively “rebate”) part or all of a premium to acquire a cryptocurrency whose price is increasing rapidly. This “credit cardholder rebate” of all or part of the premium is contemplated to be included in the scope of the invention and is not a merchant's rebate. Likewise, a credit cardholder splitting a premium with a payment solution provider, is contemplated as being within the scope of the invention. A credit cardholder may agree to, or offer, a rebate when competing against another credit cardholder to be chosen from a group of two or more credit cardholders to complete a cryptocurrency owner's financial transaction.

In a preferred embodiment, a payment solution provider using a “Transaction Exchange System”, as disclosed herein, facilitates the completion of a cryptocurrency owner's financial transaction using a credit cardholder's financial means (e.g. a credit card) that is acceptable as payment to the business (or individual) payee.

In a preferred embodiment, the payment solution provider uses the Transaction Exchange System to authenticate the participants' identities (e.g. satisfies the know your customer, anti-terrorist financing, and anti-money laundering regulations), establishes accounts (e.g. a cryptocurrency wallet), validates financial account ownership, posts cryptocurrency owner offers (i.e. cryptocurrency acquisition opportunities/open financial transactions), selects a credit cardholder, completes financial transactions, and authorizes, or participates in the authorization of, the payment of cryptocurrency to a credit cardholder.

For example, as part of a multi-signature (multisig) security protocol, the payment solution provider may hold one of three private keys (the credit cardholder and cryptocurrency owner each having one of the other two private keys) that may be used to authorize the payment of the cryptocurrency owner's cryptocurrency to the credit cardholder's cryptocurrency wallet after, or contemporaneously with, the credit cardholder's completion of the agreed upon transaction (e.g. paying for a book). The cryptocurrency owner will send the promised cryptocurrency to a public address, so the parties can see it, but not access it. The credit cardholder sees the posted funds and pays for the book (e.g. by credit card), the credit cardholder will then use his private key to authorize the payment/release of the posted cryptocurrency. If the cryptocurrency owner refuses to authorize the payment for some reason, the payment solution provider can use its private key to authorize the payment/release of the agreed upon cryptocurrency to the credit cardholder over the cryptocurrency owner's objection/refusal to cooperate. In this example, the payment solution provider acts as an arbitrator to break the tie by authorizing payment with a simple majority (i.e. providing the second private key to come to two out of the three private keys). Multisig security protocols, also known as “M-of-N signature schemes” are well known by those having an ordinary skill in the art, and so not discussed in further detail herein. The payment solution provider may charge various fees, including an account creation fee, a cryptocurrency wallet creation fee, a transaction fee, a commission, a premium sharing fee, or collect other fees for facilitating the contract formation and/or completion of a financial transaction.

In a preferred embodiment the payment solution provider will be a cryptocurrency exchange. However, a payment solution provider can be a wire/remittance service, a traditional bank, credit card company, clearinghouse, insurer, securities law firm, central bank, asset manager, accountancy, consultancy, commodity trader, credit union, escrow company, or any other entity (e.g. a municipality, state, sovereign country), or combination of them, capable of reliably performing one or more of the embodiments of the disclosed invention.

The system and method of the invention each have several aspects, no single one of which is solely responsible for its desirable attributes. Without limiting the scope of this invention as expressed by the claims which follow, it's more prominent features will now be discussed briefly. After considering this discussion, and particularly after reading the section entitled “Detailed Description of Certain Embodiments”, one will understand how the features of this invention provide advantages that include a Transaction Exchange System that enables a credit cardholder to acquire cryptocurrency in exchange for completing a cryptocurrency owner's financial transaction, plus a premium of cryptocurrency in excess of the financial transaction's cost.

One embodiment is a method to acquire cryptocurrency, where a credit card is used to complete a cryptocurrency owner's financial transaction the credit card is not the cryptocurrency owner's), and in exchange for completing the financial transaction, paying cryptocurrency equal to the cost of the financial transaction, plus a premium in the same type of cryptocurrency, to a cryptocurrency wallet designated by the credit card owner, or authorized user.

Another embodiment is a system, comprising a processor programmed to verify that a payor party has completed a cryptocurrency owner's financial transaction, wherein the payor party is not the cryptocurrency owner. The system further includes a means to authorize a payment to a cryptocurrency wallet of the payor party upon verification.

Another embodiment is a system to pay cryptocurrency as consideration for completing a financial transaction, comprising a means of authorizing a payment in cryptocurrency to a cryptocurrency wallet of a credit cardholder when it is verified that a credit card of the credit cardholder was used to complete a financial transaction; and making the payment to the cryptocurrency wallet.

These and other features, aspects and embodiments of the invention will be described in more detail below.

### BRIEF DESCRIPTION OF THE DRAWINGS

FIG. 1 is a block diagram illustrating an exemplary system in accordance with certain embodiments of the present invention.

FIG. 2 is a flow diagram illustrating an exemplary method for completing an acquisition of a cryptocurrency via a payment solution provider's transaction exchange system in accordance with certain embodiments of the present invention.

### DETAILED DESCRIPTION OF CERTAIN EMBODIMENTS

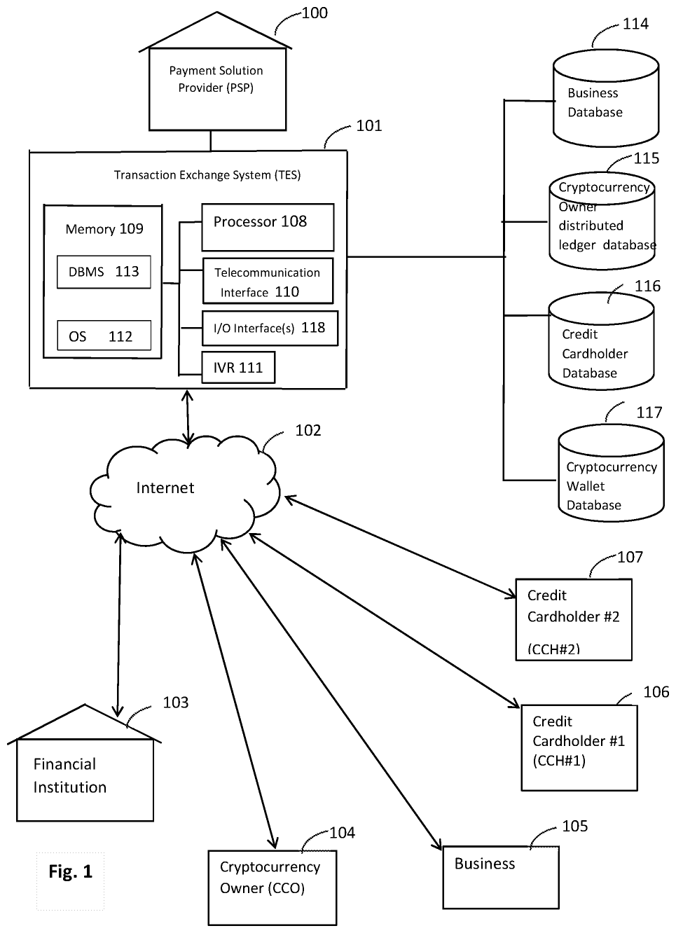

Exemplary embodiments of the present invention will hereinafter be described with references to the figures, in which like numerals indicate elements throughout the several drawings. FIG. 1 is a block diagram illustrating an exemplary operating environment for implementation of certain embodiments of the present invention. The exemplary operating environment includes a Payment Solution Provider (hereinafter “PSP”) 100 using a Transaction Exchange System (hereinafter “TES”) 101 of the present invention.

The TES 101 is preferably linked via an internet network 102 (which may be any public and/or private communication network and include wired and/or wireless segments), to at least one financial institution 103, a cryptocurrency owner (hereinafter “CCO”) 104, a business 105, and a credit cardholder (hereinafter “CCH #1”) 106. When there is a second credit cardholder (hereinafter “CCH #2”) 107 willing to accept a CCO's 104 offer, the CCH #2 107 will also be linked to the TES 101. The PSP 100 may house the TES 101, or be connected to it via the internet network 102.

As used herein, the term “financial institution” 103 should be broadly interpreted to include, but not be limited to, any bank, cryptocurrency exchange, credit card issuer or association, brokerage, wire transfer/remittance business, or other person/entity that maintains a financial account/cryptocurrency wallet, or can otherwise complete a financial transaction, or exchange of value, for another.

The TES 101 has a processor 108 and a memory 109 for storing data coupled to the processor 108. The processor 108 is configured to limit use of the TES 101 to authorized users. For example, the processor 108 may be specially programmed, so that a returning authorized user (e.g. CCH #1 106) accessing the TES 101 via a PSP 100 mobile website (not shown) may be prompted to provide a user name and password (or enable a person accessing the TES 101 for a first time to become a new authorized user) before allowing the user to view a CCO's 104 offer to complete a financial transaction in exchange for cryptocurrency.

The TES 101 is contemplated as being a processor 108 driven device, or collection of devices, that is configured for enrolling, verifying, and authenticating a participant's identification, financial account information, completing a financial transaction for a CCO 104, creating a cryptocurrency wallet, authorizing the payment of cryptocurrency to a cryptocurrency wallet, etc. The TES 101 may further be configured for accessing and reading associated computer readable media having stored thereon data/and or computer executable instructions (e.g. a “smart contract”) for implementing the various methods of the present invention. A smart contract is a digital contract that is run in a blockchain ecosystem (e.g. Ethereum Virtual Machine), that is coded so that its terms are self-executing when specified conditions occur. Smart contracts are well known by those skilled in the art, and not discussed in further detail herein. In particular, the processor 108 provides the business logic for the TES 101 that supports and provides an environment for server-side logic, expressed as objects, rules, and computations, such as selecting a credit cardholder (e.g. CCH #1 106) from a plurality of credit cardholders to source the means (e.g. a credit card) of completing a complete a financial transaction for the CCO 104.

Additionally, the TES 101 may have a telecommunication interface 110, and an interactive voice response unit (hereinafter “IVR”) 111, so that a person could call in to interact with the TES 101 and input menu options (e.g. submit an offer, check status, accept an offer, etc.) using voice, text message, or touchtone commands.

The TES 101 memory 109 may take the form of any computer readable medium. The memory 109 may be logically and/or physically divided into multiple units. The memory 109 stores data and program modules, such as an operating system (“OS”) 112, and a database management system (“DBMS”) 113. These and/or other programs may be executed by the TES 101 to perform the various methods of the present invention.

The TES 101 may include, or be in communication with, one or more searchable databases. By way of illustration only, the TES 101 may be in communication with business database 114, a cryptocurrency owner distributed ledger database (CCODL) 115, a credit cardholder database 116, and a cryptocurrency wallet database 117. These and/or other databases may also store any other data used or generated by the TES 101. Those skilled in the art will appreciate that the illustrated database may be physically and/or logically separate from one another.

The TES 101 may also include input/output (“I/O”) interfaces 118 for providing logical connections to various I/O devices, such as a scanner, a mouse, a cryptocurrency point of sale device, etc. A system administrator may utilize these and other I/O devices to interact with the TES 101. For example, a system administrator may interact with the TES 101 to populate and edit/update the CCODL 115, and other program modules. Those skilled in the art will appreciate that the TES 101 may include alternate and/or additional components, hardware, and software.

Thus configured, or similarly configured, the TES 101 may provide a means for a CCO 104 to have a financial transaction completed in exchange for paying cryptocurrency to a CCH #1 106 equal to the cost of completing the financial transaction, plus an additional cryptocurrency amount in excess of the cost (i.e. a premium), when the TES 101 is programmed to interact with a financial institution 103, a CCO 104, a business 105, and a CCH #1 106 (collectively “participants”). The premium of cryptocurrency is offered to incentivize the CCH #1's 106 participation

A CCO 104 who does not have an acceptable payment means to complete a financial transaction can have a financial transaction completed for him by a CCH #1 106 who has a payment means of completing the financial transaction that is acceptable to the payor. In a preferred embodiment, the PSP 100 does not escrow cryptocurrency to be paid to the CCH #1 106, but instead the exchange is handled between the CCO 104 and CCH #1 106 using their respective cryptographic keys. How cryptocurrency payments are made is well known by those skilled in the art and so not discussed in further detail. However, in an alternate embodiment, the PSP 100 (or other company in communication with the PSP 100, CCO 104 and CCH #1 106) may hold cryptocurrency pending the completion of the financial transaction. In another alternative embodiment, the authorization of the payment/release of cryptocurrency to the CCH #1 106 can be subject to a multisig protocol (discussed supra). This invention makes a cryptocurrency useable anywhere a business 105 accepts the CCH #1's 106 means of payment, without the need to accept cryptocurrency payments.

The PSP 100 may earn fees for facilitating the completion of financial transactions by introducing an offeror (e.g. CCO 104) to an offeree (e.g. CCH #1 106) via the TES 101, sharing in the premium paid by the CCO 104, or establishing a cryptocurrency wallet for a CCH #1 106. Participants may access the TES 101 via a PSP 100 mobile website (not shown) to update/query information databases 114-117, submit offers, submit acceptances, etc. Additionally, the TES 101 may access the various databases 114-117 to update and check for new information (e.g. credit CCH #1's 106 cryptocurrency wallet in the cryptocurrency wallet database 117, authenticate cryptocurrency ownership, etc.).

A person wishing to become an authorized user of the TES 101 may preferably do so by accessing the PSP's 100 website (not shown) via a computer (e.g. smart phone) having internet 102 access. In an alternate embodiment, a person may become an authorized user and access the TES 101 using a phone to communicate over a wired or wireless network (not shown) with the telecommunication interface 110 and IVR 111 using voice or touchtone commands.

In yet another alternate embodiment, a person may become an authorized user of the TES 101 by going in person to a PSP's 100 physical location. For example, when the PSP 100 is a financial institution 103, the PSP 100 could offer the PSP's 100 service as an add-on feature to a customer opening a checking account.

The financial institution 103 may provide financial services, as well as provide and/or verify information to the TES 101 (e.g. confirm identity of a CCH #1 106). When the financial institution 103 provides a physical location for a CCO 104, the financial institution 103 may be able to acquire new business from the CCO 104.

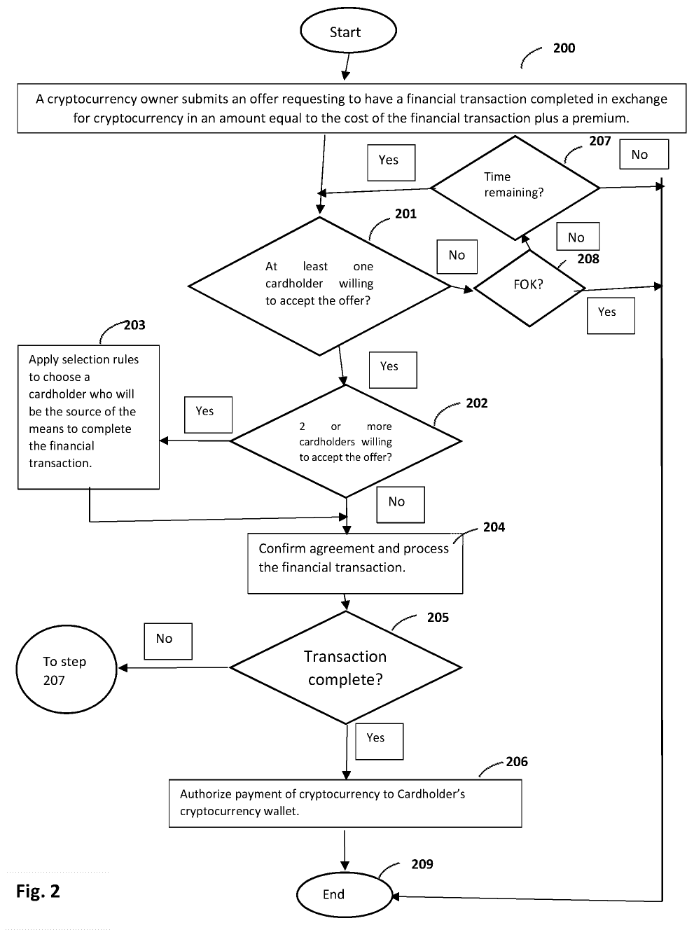

FIG. 2 is a flowchart demonstrating, in further detail, one method of employing the TES 101 such as that of FIG. 1, to make an exchange for a CCO 104, using a CCH #1's 106 means of payment, according to one of the embodiments of the invention.

In this embodiment, a CCO 104 may have a financial transaction completed with a business 105 that does not accept cryptocurrency payments. It should be understood that the term “dollar” and “$” symbol is meant to include any currency that the financial transaction and/or cryptocurrency is priced in. A CCH #1 106 can submit preferences to the PSP 100 via the TES 101 that prohibit where his financial resource(s) (e.g. a credit card) are to be used (e.g. a country, a bar, a country bar), or what types of financial transactions he does not want to have completed with his financial resource(s) (e.g. no political donations).

While the example will discuss the financial transaction as a “purchase”, it should be understood that the term “purchase” is to be broadly construed to include any payment by the CCH #1's 106 to a payee of the CCO's 104 choosing.

Further, while the example uses an “online business”, the invention includes any payee, online or offline, capable of being paid by a CCH #1's 106 financial means. So, an “in person” exchange is also contemplated within the scope of the invention when a CCO 104 and CCH #1 106 are at the same business 105 location, as some people prefer to conduct business “face to face”.

In a preferred embodiment, the TES 101 will execute all financial transactions automatically when the TES 101 matches a CCO's 104 offer to complete a financial transaction in exchange for cryptocurrency with a CCH #1's acceptance of that offer. The CCO's 104 submission of an offer demonstrates the CCO's 104 intent to be contractually bound upon acceptance of the CCO's 104 offer by any authorized user of the TES 101 (e.g. a CCH #1 106 offeree). The offer includes, at least, the dollar amount of the proposed financial transaction to be completed, and the consideration to be paid in exchange for completing the financial transaction. The term “dollar amount” includes an estimated maximum dollar amount. Additionally, the offer may include a time in which the offer must be accepted before it is revoked. Further, an offer may include a term that states that any premium of cryptocurrency offered will diminish as long as the offer remains open, or the financial transaction remains incomplete, to incentivize a quick acceptance of the CCO's 104 offer.

In a preferred embodiment, the consideration paid to the CCH #1 106 is the CCO's 104 cryptocurrency in an amount equal to the cost to complete the financial transaction, plus a premium. The financial transaction may be denominated in the currency that is to be used to complete the financial transaction. However, in an alternate embodiment, the consideration paid to the CCH #1 106 can be less than the cost to complete the financial transaction, and/or include no premium. This alternate embodiment may be used when the transaction is denominated in a currency that is quickly devaluing against the cryptocurrency offered.

The CCO 104 and CCH #1 106 may have an account with the PSP 100, or may register as a new authorized user and initiate the following procedure via the TES 101 at the time of submitting their respective offer and acceptance. In a preferred embodiment, the TES 101 will be implemented by the PSP 100, and the identity of each participant, as well as ownership of their respective financial/cryptocurrency accounts will have been previously verified (e.g. through a query to a participant's financial institution 103, CCODL 115, affidavit, etc.), and each will have been issued one or more unique identifiers (e.g. username, password, private key) to complete an exchange.

The PSP 100, acting as a facilitator among the financial institution 103, CCH #1 106, and CCO 104, provides a secure platform in verifying the identity of parties, matching offerors and offerees, forming contracts, verifying completion of financial transactions, and as necessary, authorizing payments.

In a preferred embodiment the PSP 100 does not escrow funds, but instead is pre-authorized to complete (automatically, semi-automatically, or manually) a CCO's 104 financial transaction. However, the authorization to pay, or release, cryptocurrency can be subject to a multisig security protocol as detailed above (i.e. a simple majority of private key holders). In this way, the PSP 100 provides a trusted venue for participants to make an exchange of value.

In an alternate embodiment, The PSP 100 may hold the CCO's 104, or CCH #1's 106 payment in escrow (or use a third-party escrow company, not shown) until a condition's occurrence (precedent, concurrent, or subsequent) that was agreed upon by the CCO 104 and CCH #1 106 takes place. Further, the PSP 100 may auction a CCO's 104 offer, when there are at least two credit cardholders (i.e. a second credit cardholder (hereinafter “CCH #2” 107)) who is linked to the TES 101 and may be willing to accept the CCO's 104 offer (e.g. as indicated by the CCH #2's 107 purchase transaction history, survey results, etc.).

At step 200 a CCO 104 submits an offer to complete a financial transaction for the CCO 104 to the PSP's 100 TES 101 (e.g. purchase a book for the CCO 104 from an online business 105). The CCO's 104 offer includes terms, including the cost of the proposed financial transaction, an acceptable payment means (e.g. PayPal) to complete the financial transaction, and the consideration to be paid in exchange for completing the financial transaction (e.g. cryptocurrency equal to the cost of the financial transaction plus a cryptocurrency premium to be paid to a CCH #1's 106 cryptocurrency wallet).

The “cost” of the proposed financial transaction includes an estimated total cost, a price range (min-max), or a cost ceiling (e.g. “a total cost not to exceed $100.00.”). Further, the premium can be stated as a fixed amount of cryptocurrency, or a percentage of the cost. In a rapidly rising cryptocurrency market the premium may be a “negative premium”, as expressed as a negative percentage of the cost to complete the financial transaction, or as a negative fixed amount (i.e. the CCH #1 106 will receive an amount of cryptocurrency that is less than the total cost of the financial transaction).

After receiving the CCO's 104 offer, the method then proceeds to step 201 where it is determined whether or not there is at least one CCH #1 106 willing to accept the CCO's 104 offer (e.g. buy a book for the CCO 104). If not, the method proceeds to step 208 and determines if there is a CCO 104 “Fill or Kill” (FOK) instruction that requires the CCO's 104 offer to be immediately accepted, or otherwise revoked. In this context, “immediately” means a short period of time (for example 30 seconds from the time the TES 101 receives the offer) and is not meant to require the offer to be accepted simultaneously as it is received by the TES 101.

If there is no CCH #1 106 that accepts the CCO's 104 offer, and a there is a FOK instruction, the method proceeds to step 209 and ends. The CCO 104 may be offered the opportunity to amend the offer to increase the premium offered and resubmit (not shown), wherein the method proceeds back to step 200. If there is no CCH #1 106 and no FOK instruction, the method proceeds to step 207 to determine if there is time remaining for the offer to be accepted. If there is not, the method proceeds to step 209 and ends. If time remains for acceptance, the method goes back to step 201. The PSP 100 may impose its own time limit for this loop to continue, before the PSP 100 deems the offer revoked and notifies the CCO 104. This is to a protect a CCO 104 from being unhappily surprised by a forgotten offer.

If it is determined that there is at least one CCH #1 (106) that will accept the CCO's 104 offer, then the method proceeds to step 202 and determines whether there is at least one additional credit cardholder CCH #2 107 that is willing to accept the CCO's 104 offer. If there is, the method proceeds to step 203 and TES 101 uses one or more rules to select the credit cardholder to complete the CCO's 104 financial transaction. For example, the rule may be “first in time, first in right” to select a credit cardholder from among two or more credit cardholders. Alternatively, the rule may include selecting the credit cardholder that will accept the smallest, or no premium of cryptocurrency.

Yet in another alternate embodiment, the selection may be based on which credit cardholder is willing to split a premium with the PSP 100. In another embodiment, the selection may be based on which credit cardholder will rebate a part/all of the premium to the CCO 104. In yet another embodiment, the credit cardholder willing to accept the largest loss (i.e. the largest negative premium) in completing the financial transaction will be selected. This last rule can be used when the cryptocurrency is rising rapidly in price. This, or other selection rules, or combinations of them, may be used to select a CCH #1 106.

Once a CCH #1 106 is selected from among two or more credit cardholders (e.g. CCH #1 106 and CCH #2 107), or if there is only one CCH #1 106 willing to accept the CCO's 104 offer, the method proceeds to step 204 where, in a preferred embodiment, the agreement is confirmed automatically by the TES 101 and a contract is formed. In alternative embodiment the TES 101 may contact the CCH #1 106 to have CCH #1 106 verify acceptance (e.g. via a SMS response, or responding to a link to the CCH #1's 106 email, etc.).

Upon contract formation, the TES 101 processes the financial transaction for the CCO 104 (e.g. initiates a credit card purchase of the book for the CCO 104). In an alternative embodiment, when the agreement between the CCO 104 and CCH #1 106 was made via a smart contract, the terms would begin to self-execute. The method proceeds to step 205 where it is determined if the transaction is completed (e.g. payment was authorized), and if so the method proceeds to step 206 where the agreed upon CCO's 104 cryptocurrency is paid to the CCH #1's 106 cryptocurrency wallet. In a preferred embodiment, the PSP 100 will create a cryptocurrency wallet for the CCH #1 106 upon acceptance of the CCO's 104 offer when the CCH #1 106 has no cryptocurrency wallet. However, the cryptocurrency may be paid to any existing cryptocurrency wallet of the CCH #1's 106 choice. The method then proceeds to step 209 and ends.

At step 205, if the transaction did not complete (e.g. CCH #1's 106 credit card authorization was denied, insufficient funds, etc.), the method proceeds to step 207 to determine if there is any time remaining to accept the CCO's 104 offer, and the method proceeds as previously described above. In an alternate embodiment, when transaction completion fails at step 205, the TES 101 may select CCH #2 107 to complete the financial transaction when there is another credit cardholder (e.g. CCH #2 107) willing to accept CCO's 104 offer.

As may be seen from the foregoing, the present invention provides a system and method for a cryptocurrency owner to complete a financial transaction with a business, when the business does not accept cryptocurrency payments (or at least does not accept the type of cryptocurrency that the cryptocurrency owner owns/controls), via an exchange with a credit cardholder who wishes to acquire cryptocurrency without paying an additional fee over the market value of the cryptocurrency, and in a preferred embodiment will receive a premium of cryptocurrency. Also, the present invention allows for the acquisition of cryptocurrency without directly purchasing a cryptocurrency, and using something other than a debit (i.e. credit) to do so.

It should be appreciated that the exemplary aspects and features of the present invention as described above are not intended to be interpreted as required or essential elements of the invention, unless explicitly stated as such. It should also be appreciated that the foregoing description of exemplary embodiments was provided by way of illustration only and that many other modifications, features, embodiments and operating environments are possible. Accordingly, the scope of the present invention should be limited only by the claims to follow.

1. A method to acquire cryptocurrency, comprising:
using a credit card to complete a cryptocurrency owner's financial transaction, wherein the cryptocurrency owner is neither an owner or authorized user of the credit card that is used to complete the financial transaction; and
in exchange for completing the financial transaction, paying cryptocurrency equal to the cost of the financial transaction, plus a premium in the same type of cryptocurrency, to a cryptocurrency wallet chosen by the credit card owner or authorized user of the credit card used to complete the financial transaction.

2. The method of claim 1, including the step of an authorized user of the credit card designating the cryptocurrency wallet to receive payment.

3. The method of claim 1, wherein the financial transaction includes a payment type that does not include a cryptocurrency.

4. The method of claim 1, wherein the credit card is a group, the group comprising one of a credit card, a credit line, a debit card, a prepaid card, a checking account, a brokerage account, a wire transfer, a savings account, and a cryptocurrency of a different type than the type of cryptocurrency that is paid to the cryptocurrency wallet.

5. The method of claim 1, wherein the payment is made by a trustee of a trust that holds cryptocurrency.

6. The method of claim 1, wherein the premium diminishes for the duration that the financial transaction remains incomplete.

7. The method of claim 1, wherein the premium is not fixed.

8. The method of claim 1, further comprising the step of selecting the credit from among a group comprising least two credit cardholders.

9. A cryptocurrency exchange system, comprising:
a processor programmed to allow a payor party to accept a cryptocurrency owner's offer to complete a financial transaction, wherein the financial transaction is not a purchase of cryptocurrency; and
a means to authorize a payment to a cryptocurrency wallet of the payor party in exchange for completing the cryptocurrency owner's financial transaction.

10. The system of claim 9, wherein the payment authorized is equal to the cost of the financial transaction plus a premium.

11. The system of claim 9, wherein the means to authorize payment includes a multi-signature security protocol that requires a majority of private key holders to authorize the payment, and one of the private keys is not held by the payor party or cryptocurrency owner.

12. The system of claim 9, wherein the payor is selected from among two or more potential payors by a criterion, the criterion includes selecting the payor who agrees to accept the least amount of cryptocurrency.

13. The system of claim 9, wherein the financial transaction is a group, the group including one of a payment of an installment contract, a mortgage payment, and a reoccurring payment that is neither an installment contract payment or a mortgage payment.

14. The system of claim 9, wherein the authorized payment is less than the cost to complete the financial transaction.

15. A system to pay cryptocurrency as consideration for completing a financial transaction, comprising:
a means of authorizing a payment to a cryptocurrency wallet of a credit cardholder when it is verified that a credit card of the credit cardholder was used to complete a financial transaction; and
making the payment to the cryptocurrency wallet.

16. The system of claim 15, wherein the means of authorizing payment is done by a smart contract.

17. The system of claim 16, wherein the smart contract includes the condition that at least a majority of private key holders must agree to authorize payment when there are at least three parties having a private key that can authorize payment.

18. The system of claim 17, wherein at least one of the private key holders is neither the credit cardholder or the owner of the cryptocurrency.

19. The system of claim 15, wherein the credit cardholder is selected from among two or more credit cardholders.

20. The system of claim 15, wherein the payment amount is at least equal to the cost of completing the cryptocurrency owner's financial transaction.
